(19) United States
(12) Patent Application Publication
(10) Pub. No.: US 2013/0277873 A1
(43) Pub. Date: Oct. 24, 2013

(54) METHOD FOR MANUFACTURING A DENTAL PROSTHESIS

(71) Applicant: Michael Sadoun, Paris (FR)

(72) Inventor: Michael Sadoun, Paris (FR)

(73) Assignee: Michael SADOUN, Paris (FR)

(21) Appl. No.: 13/988,403

(22) PCT Filed: Nov. 18, 2011
(86) PCT No.: PCT/IB11/55178

§ 371 Date: Jun. 26, 2013

(30) Foreign Application Priority Data
Nov. 19, 2010 (FR) 10 59519

(51) Int. Cl. A61C 13/00; A61C 5/10

(52) U.S. Cl. CPC A61C 13/0006; A61C 5/10; A61C 13/0004
USPC 264/16

(57) ABSTRACT

A method of fabricating a dental prosthesis, the method comprising the following steps:
a) preparing a paste by mixing a particulate filler and a resin suitable for forming a binder phase by hardening;
b) hardening the paste prepared in step a), optionally after shaping it, so as to form a solid composite mass;
c) optionally cutting the solid composite mass so as to form at least one composite block; and
d) optionally machining the composite block so as to form a dental prosthesis;
in which method, in step b) the hardening is performed at a pressure greater than 500 bar, and the pressure is returned to atmospheric pressure once all of the resin has hardened.

### TECHNICAL FIELD

The invention relates to a method of fabricating a composite block for fabricating a dental prosthesis, and to a method of fabricating a dental prosthesis. The invention also relates to a composite block and to a dental prosthesis obtained or suitable for being obtained by such methods.

### STATE OF THE ART

Composite blocks are known that are fabricated by hardening a composite paste, i.e. a paste comprising a particulate filler, conventionally of ceramic material or of glass, and a resin, conventionally a mixture of monomers.

In order to fabricate such a composite block, the paste is shaped and then hardened. After solidifying, the resin forms a binder phase or “matrix” that binds the particles together. The resulting composite block is then machined to the shape desired for the prosthesis, conventionally using computer-aided design-computer-aided machining (CAD-CAM).

The 3M Paradigm M210C block from the supplier 3M is an example of a composite block fabricated in this way.

Composite blocks fabricated using existing methods nevertheless present low mechanical strength, which limits their lifetime as dental prostheses.

An object of the invention is to provide a novel method enabling the properties of dental prostheses to be improved, in particular by increasing their mechanical strength and their chemical stability.

### SUMMARY OF THE INVENTION

According to the invention, this object is achieved by means of a method of fabricating a dental prosthesis, the method comprising the following steps:

a) preparing a paste by mixing a particulate filler and a resin suitable for forming a binder phase by hardening;

b) hardening the paste prepared in step a), optionally after shaping it, so as to form a solid composite mass;

c) optionally cutting the solid composite mass so as to form at least one composite block; and

d) optionally machining the composite block so as to form a dental prosthesis.

This method is remarkable in that, in step b), the hardening is performed, at least in part and preferably completely, at a pressure greater than 500 bar.

As explained in detail below in the description, a method of the invention makes it possible in simple manner to fabricate composite blocks presenting very high mechanical strength.

Without being tied to this particular theory, the inventor explains the performance obtained by the fact that the pressure applied in step b) serves to create stress that is suitable for compensating the shrinkage that occurs during hardening of the resin. This results in a reduction in the number of defects.

The invention also provides a solid composite mass, a composite block, and a dental prosthesis as obtained from a step b), a step c), or a step d), respectively, of a method of the invention, or suitable for being fabricated by implementing such steps.

### Definitions

The term “dental prosthesis is used in general manner to designate any piece for placing amongst the teeth of a patient in order to restore them in full or in part to their natural shape.

Thus, dental prostheses fabricated by the invention may for example be peripheral caps or crowns that are placed on the stump of a natural tooth, or prostheses of the kind generally referred to as “inlays” or “onlays” that serve to reconstitute partial damage to a tooth by filling the cavity that results from the tooth losing substance with a part having the same shape and made by a prosthetist, or indeed bridges, which are prostheses that bear simultaneously on the remaining portions of at least two teeth, possibly compensating for one or more missing teeth.

Unless specified to the contrary, the term “pressure” is used to designate the above-mentioned high pressure as applied in step b). By default, the term “pressure” therefore does not designate “atmospheric pressure”.

The term “comprising a” should be understood as “comprising at least one”.

### DETAILED DESCRIPTION

A dental prosthesis of the invention may be fabricated by a method comprising steps a) to d) above: In step a), using well-known methods, a paste is prepared by mixing a particulate filler and a resin suitable for forming a binder phase by hardening.

The particulate filler preferably represents more than 60%, more than 70%, or even more than 80%, and/or less than 90% of the weight of the paste.

Preferably, the resin and the particulate filler together represent more than 90%, more than 95%, more than 98%, more than 99%, or indeed substantially 100% of the weight of the paste.

### Particulate Filler

It is possible to implement the particulate fillers and the resins that are presently in use for fabricating dental prostheses, in particular by injection.

Preferably, the particulate filler comprises, or indeed is constituted by, particles of a material selected from a metallic oxide in vitroceramic or glass form, or in the form of a crystalline ceramic such as silica, quartz, alumina, or mullite, or by a mixture of such particles.

Also preferably, the particulate filler comprises, or indeed is constituted by, particles of a material selected from a barium aluminosilicate glass, a glass containing ytterbium fluoride, albite, a micatetrafluoro silicate, a lithium disilicate, apatite, quartz, MgAl₂O₄ spinel, mullite, and zircon, or by a mixture of such particles.

The particles of the particulate filler may be subjected to silaning treatment for increasing the ability of their surface to be wetted by the resin in the liquid state, and in particular for the purpose of making said surface more hydrophobic. This silaning treatment preferably comprises silanizing by means of alcoxysilane, halosilane, and preferably 3-methacryloxypropyl trimethoxysilane. After applying the silaning agent, the particles are dried, preferably at a temperature lying in the range 100° C. to 200° C., conventionally for several hours.

By way of example, the silaning treatment may be performed in accordance with the method described in U.S. Pat. No. 5,869,548.

### Resin

The nature of the resin is not limiting.

Preferably, the resin is chemopolymerizable, thermopolymerziable, or thermoplastic.

In particular, the resin may be selected from polymerizable resins, in particular those described in U.S. Pat. No. 5,869,548, U.S. Pat. No 5,843,348, and EP 0 701 808.

Preferably, the resin is selected from the following list:
a chemopolymerizable or thermopolymerizable monomer resin, preferably a vinyl ester or acrylic resin. The resin may in particular be selected from the group formed by: 2-hydroxyethyl methacrylate, CAS 868-77-9 (HEMA); tetraethylene glycol dimethacrylate, CAS 109-17-1 (TEGDMA); 2,2-bis-(4-(2-hydroxy-3-methacryloyloxy-propoxy)phenyl)propane, CAS 1565-94-2 (BIS-GMA); urethane dimethacrylate 1, 6-bis (methacryloxy-2ethoxycarbonylamino)-2,4,4-trimethylhexane, CAS 72869-86-4 (UDMA); ethylene-glycol-dimethacrylate (EGDMA); diethylene-glycol-dimethacrylate (DEGDMA); and bisphenol A-dimethacrylate, CAS 109-17-1 (BADMA);
a thermoplastic resin, in particular selected from: saturated polyesters, and in particular polyethylene terephthalate (PET) and poly(1,4-butylene terephthalate) CAS 24968-12-5 (PBT); polycarbonates; poly(bisphenol A carbonate), CAS 25037-45-0 (PC); bisphenol A carbonate; and polyamides.

In particular, in order to catalyze chemopolymerizable resins, it is possible to use peroxides, in particular: dibenzoylperoxide, CAS 94-36-0; methyl ethyl ketone peroxide, CAS 1338-23-4; di-tert-amyl peroxide CAS 10508-09-5, di-tert-butyl peroxide, CAS 110-05-4; or cumene hydroperoxide CAS 80-15-9.

To accelerate the hardening of the dibenyzoylperoxide CAS 94-36-0, it is possible to use dimethyl-aniline (DMA), diethyl-aniline (DEA), or dimethyl-para-toluidine (DMPT). To accelerate the hardening of the methyl ethyl ketone peroxide CAS 1338-23-4, it is possible to use cobalt (II) 2-ethylhexaonoate, in particular.

In conventional manner, the paste may also include additives that make it easier to control the hardening thereof, e.g. a catalyst and/or an accelerator.

Preferably, the total content by weight of additives is less than 2% of the weight of the paste.

Optionally, the paste is shaped, e.g. into the shape of a “brick”, a plate, or in particular a disk. The maximum thickness of a plate of the invention is preferably less than 30 mm, preferably less than 20 mm, preferably less than 15 mm, and/or greater than 5 mm, greater than 8 mm.

In step b), the paste prepared in step a) is hardened so as to form a solid composite mass.

To control the hardening of the paste, it is possible in conventional manner to act on one or more of the following parameters:
the concentration of accelerator and/or catalyst in the paste;
the temperature and the length of time said temperature is maintained; and
the chemical nature of the resin, and in particular of the monomers.

In the prior art, the resin is conventionally polymerized at ambient pressure. The shrinkage that results from polymerizing at ambient temperature may conventionally lead to a reduction in the volume occupied by the resin lying in the range 6% to 15% of its initial volume. This shrinkage leads to the appearance of defects that generally present a size lying in the range 35 micrometers (μm) to 100 μm.

According to the invention, the paste is subjected to high pressure, higher than 500 bar, at least until a fraction and preferably all of the paste has hardened. The high pressure serves to compensate for the shrinkage, at least in part. This results in very great homogeneity, an increase in density, and a reduction in the number and the sizes of defects, or even to a disappearance of defects. Mechanical strength is considerably improved thereby.

In step b), the pressure is preferably greater than 600 bar, preferably greater than 800 bar, greater than 1000 bar, greater than 2000 bar, or even greater than 3000 bar, or even greater than 4000 bar. Preferably, the pressure is nevertheless less than 5000 bar, preferably less than 4000 bar. In a preferred implementation, the pressure lies in the range 2000 bar to 3000 bar.

The pressure is preferably determined in such a manner as to produce a reduction in the volume of the paste that is greater or equal to the reduction that would result at atmospheric pressure from the shrinkage that results from the resin hardening.

By way of indication, for the resin, the pressure may be set as follows, as a function of the shrinkage measured at 20° C.

| Pressure | Shrinkage |
|---|---|
| 500 bar | −2.3% |
| 1000 bar | −4.18% |
| 1500 bar | −5.7% |
| 2000 bar | −7% |
| 2500 bar | −8.3% |
| 3000 bar | −9.3% |
| 3500 bar | −10.2% |
| 4000 bar | −11.1% |
| 4500 bar | −11.9% |
| 5000 bar | −12.6% |

Conventional injection methods are not adapted to applying such high pressures. Furthermore, injection under pressure is often implemented only for improving filling of the mold.

Preferably, the pressure is exerted in isostatic or “uniaxial” manner. Any known method of applying pressure may be used. The pressure must be exerted on the paste while the resin is still at least partially, and preferably completely, in the liquid state and until it has hardened, at least in part. Preferably, all of the resin is hardened, preferably polymerized to more than 30% by weight, preferably to more than 50% by weight, preferably to more than 80% by weight, preferably to more than 99% by weight, and preferably to substantially 100% by weight, before returning to atmospheric pressure. Preferably, the pressure is maintained substantially constant until all of the resin has hardened.

The polymerization may be chemical. The polymerization is preferably thermal.

During step b) it is preferable to apply a temperature that is preferably greater than 60° C., or even greater than 80° C., or greater than 100° C., and/or less than 220° C., preferably less than 200° C., preferably less than 160° C., preferably less than 150° C.

When a catalyst is added to the paste, polymerization is preferably performed at a temperature lying in the range 60° C. to 160° C., preferably in the range 60° C. to 150° C. When no catalyst is added to the paste, polymerization is preferably performed at a temperature lying in the range 150° C. to 220° C., preferably in the range 150° C. to 200° C., preferably in the range 160° C. to 200° C.

Temperature and/or the pressure is maintained for a duration that is preferably greater than 0.25 hours (h), preferably more than 0.5 h and/or less than 2 h, preferably less than 0.75 h.

Applying a high pressure at a temperature greater than 150° C., preferably greater than 160° C., and preferably less than 220° C., preferably less than 200° C. serves advantageously to open the carbon double bonds in the monomers of the resin, in particular when the resin is a methacrylate or a polyacrylate in the liquid state, i.e. without the resin boiling or evaporating. It is thus possible to polymerize it without adding any catalyst, which is particularly advantageous since catalysts are often potentially toxic.

Hardening by thermopolymerization using hot isostatic pressing (HIP) is the most preferred technique.

Preferably, during step b), the pressure is maintained substantially constant, with the variation in pressure preferably being less than 20%, preferably less than 10% of the maximum applied pressure.

Preferably, the pressure is maintained substantially constant until the resin has polymerized to more than 30% by weight, preferably to more than 50% by weight, preferably to more than 80% by weight, preferably to more than 99% by weight, preferably to substantially 100% by weight.

Preferably, the resin is hardened by performing only one operation of applying pressure without returning to ambient pressure.

Preferably, a return to ambient pressure is not undertaken until after the hardened composite mass has cooled, preferably down to ambient temperature.

Where appropriate, the solid composite mass may be subjected to heat treatment for finishing off the polymerization, e.g. at a temperature lying in the range 150° C. to 180° C.

Preferably, the solid composite mass results from the paste being thermopolymerized under pressure. The solid composite mass obtained at the end of step b) of the invention preferably presents hardness greater than 100 on the Vickers scale, preferably greater than 120 Vickers, or even greater than 140 Vickers.

Preferably, the solid composite mass obtained at the end of step b) presents a Young's modulus that is greater than 5 gigapascals (GPa) measured in application of the ISO 10 477 standard and/or a three-point bending modulus, measured in application of the ISO 6 872 standard that is greater than 100 megapascals (MPa), preferably greater than 150 MPa, or even greater than 200 MPa.

Furthermore, the optical properties of the solid composite mass make it entirely suitable for fabricating a dental prosthesis.

Preferably, no intermediate step is performed between steps b) and c).

In step c), the solid composite mass is cut so as to form one or more composite blocks adapted to the machines that are used for the following steps.

The solid composite mass may be in the form of a plate, preferably of substantially constant thickness. Preferably, the solid composite mass is in the form of a stick. The section of the stick may be square, or rectangular, or circular. Preferably, the solid composite mass presents at least one face that is plane. Preferably, the solid composite mass presents a shape that is convex. Preferably, the solid composite mass presents at least two parallel faces.

The smallest dimension of the solid composite mass is preferably less than 30 mm, preferably less than 20 mm, preferably less than 15 mm, and/or preferably greater than 5 mm.

The greatest dimension of the solid composite mass, or indeed each of its dimensions, is preferably greater than 15 mm, preferably greater than 50 mm, preferably greater than 100 mm.

The volume of the solid composite mass is preferably greater than 20,000 mm³, preferably greater than 50,000 mm³, preferably greater than 100,000 mm³.

Preferably, the solid composite mass may be cut up into a plurality of composite blocks, preferably into at least two composite blocks, into at least three composite blocks, preferably into at least five composite blocks, preferably into at least ten composite blocks, and preferably into at least twenty composite blocks. Preferably, all of the composite blocks derived from a common solid composite mass are substantially identical.

Preferably, the solid composite mass is the result of the paste prepared in step a) being thermopolymerized under pressure, which composite mass is then cut up into at least three composite blocks.

Preferably, a composite block presents a shape that is convex. Preferably, a composite block presents at least one surface that is plane, which surface may for example present stripes that result from an operation of cutting by sawing. Preferably, a composite block does not present the shape of a tooth obtained by molding. A composite block is preferably of rectangular shape, preferably of cubic shape. It may be of cylindrical shape or of prismatic shape.

Preferably, the smallest dimension of a composite block, or indeed each of its dimensions, is greater than 5 mm, preferably greater than 10 mm, preferably greater than 20 mm, and/or preferably less than 40 mm, preferably less than 30 mm.

The volume of a composite block is preferably greater than 125 mm³, preferably greater than 1000 mm³, preferably greater than 5000 mm³, preferably greater than 10,000 mm³, and/or preferably less than 100,000 mm³, preferably less than 50,000 mm³. Preferably, step c) is performed in such a manner that the resulting composite block(s) is/are suitable for being machined by a CAD-CAM device, in particular a machining device such as the Celay® system from the supplier Mikrona, or Cerec 3 from the supplier Sirona. Where appropriate, one or more members are incorporated in the composite block to enable it to be held by such devices.

Preferably, the cutter device is suitable for forming a plurality of composite blocks, e.g. all of identical shape, e.g. all in the shape of a cube. In an embodiment, the cutter device makes it possible, e.g. in a plurality of operations, to form composite blocks of identical shape by cutting up a plurality of composite masses of various dimensions.

Preferably, one of the faces of a composite block is adhesively bonded on a metal part, the metal part including a rod for being fastened in a chuck of a CAD-CAM device, the rod presenting a flat that serves to reference and to orient the composite block.

In step d), the composite block is machined so as to form a dental prosthesis. The machining of a dental prosthesis is preferably adapted so that the prosthesis fits the patient's tooth or teeth for care and/or for restoring and/or for reconstructing.

The ratio of the quantity of material removed from the composite block by machining over the quantity of material of the composite block before machining in order to form a dental prosthesis, is preferably greater than 10%, preferably greater than 30%, preferably greater than 50%, preferably greater than 70%, and/or preferably less than 90%, preferably less than 80%. Depending on the nature of the dental prosthesis that is fabricated, the composite block of the invention may be secured to other parts, e.g. metal-based parts.

The succession of steps a), b), and c) may be repeated identically, preferably in such a manner as to obtain composite blocks of calibrated dimensions at the end of step c).

By way of example, the steps a), b), and c) may be performed at the same place, e.g. in the workshops of a factory. One or more composite blocks may be packaged and then shipped to a place for machining as described in step d). By way of example, this place may be the workshop of a dental prosthetist having a machining device for performing step d).

### EXAMPLES

The following examples are provided for illustrative and non-limiting purposes.

### Example 1

The particulate filler was a material constituted for 80% by weight of a barium aluminosilicate glass powder with a particle size lying in the range 0.1 μm to 5 μm, with the balance to 100% being a colloidal silica powder with a particle size lying in the range 20 nanometers (nm) to 50 nm.

The particulate filler was subjected successively to:
silaning treatment using a solution presenting the following composition in percentages by weight:

| | |
|---|---|
| methoxypropanol: | 93.8% |
| water: | 5% |
| acetic acid: | 0.2% |
| silane: | 1% |

drying at 150° C. for 4 h.

The resin presented the following composition in percentages by weight:

| | |
|---|---|
| UDMA: | 80% |
| TEGDMA: | 19.2% |
| benzoyl peroxide: | 0.8% |

The paste was obtained by mixing 75% by weight of the particulate filler and 25% by weight of resin.

The paste as obtained in that way was subsequently hardened at a pressure of 500 bar, by thermopolymerization at 100° C. for 1 h.

### Example 2

The particulate filler was a mixture constituted, for 70% by weight, of a SiO₂ quartz power having particle size lying in the range 0.1 μm to 2 μm, the balance to 100% being a colloidal silica powder having particle size lying in the range 5 nm to 75 nm.

The particulate filler was subjected to silaning treatment identical to that of Example 1.

The resin presented the following composition in percentages by weight:

| | |
|---|---|
| BIS-GMA: | 40% |
| UDMA: | 28% |
| TEGDMA: | 30% |
| MEKP: | 2% |

The paste was obtained by mixing 80% by weight of the particulate filler with 20% by weight of the resin.

The paste obtained in that way was then hardened at a pressure of 1000 bar, by thermopolymerization at 80° C. for 2 h.

### Example 3

The particulate filler was a mixture constituted, for 50% by weight, of an NaAlS₃O₈ albite vitroceramic powder with a particle size of about 10 μm, and for 20% by weight of a barium aluminosilicate glass powder of particle size lying in the range 0.4 μm to 1 μm, the balance to 100% being a colloidal silica powder of particle size lying in the range 50 nm to 100 nm.

This particulate filler was subjected to silaning treatment identical to that of Example 1.

The resin presented the following composition, in percentages by weight:

| | |
|---|---|
| EBADMA: | 99.68% |
| Benzoyl peroxide | 0.3% |
| DMPT: | 0.02% |

The paste was obtained by mixing 70% by weight of the particulate filler and 30% by weight of the resin.

The paste obtained in this way was then hardened at a pressure of 2000 bar, by thermopolymerization at 130° C. for 0.5 h.

### Example 4

The particulate filler was a mixture constituted, for 70% by weight, of a barium aluminosilicate glass powder with a particle size of about 1 μm, and for 10% by weight of a YbF₃ yttrium fluoride powder having a particle size of about 3 μm, the balance to 100% being a colloidal silica powder of particle size lying in the range 20 nm to 50 nm.

This particulate filler was subjected to silaning treatment identical to that of Example 1.

The resin presented the following composition, in percentages by weight:

| | |
|---|---|
| BIS-GMA: | 50% |
| DEGDMA: | 50% |

The paste was obtained by mixing 60% by weight of the particulate filler and 40% by weight of the resin.

The paste obtained in this way was subsequently hardened at a pressure of 3000 bar by thermopolymerization at 180° C. for 1.5 h.

### Example 5

The particulate filler was a mixture constituted, for 80% by weight, of an alumina powder of particle size of lying in the range 0.3 μm to 5 μm, the balance to 100% being a colloidal silica powder of particle size lying in the range 50 nm to 100 nm.

This particulate filler was subjected to silaning treatment identical to that of Example 1.

The resin was a UDMA resin.

The paste was obtained by mixing 90% by weight of the particulate filler and 10% by weight of the resin.

The paste obtained in this way was subsequently hardened at a pressure of 4000 bar, by thermopolymerization at 200° C. for 0.5 h.

### Example 6

The particulate filler was a mixture constituted, for 60% by weight, of a mullite powder of particle size lying in the range 1 μm to 10 μm, and for 20% by weight of a silica powder of particle size lying in the range 0.1 μm to 1 μm, the balance to 100% being a colloidal silica powder of particle size lying in the range 20 nm to 50 nm.

This particulate filler was subjected to silaning treatment identical to that of Example 1.

The resin presented the following composition, in percentages by weight:

| | |
|---|---|
| EBADMA: | 80% |
| EGDMA: | 19.16% |
| Benzoyl peroxide: | 0.8% |
| DMPT: | 0.04% |

The paste was obtained by mixing 75% by weight of the particulate filler and 25% by weight of the resin.

The paste obtained in this way was subsequently hardened at a pressure of 3000 bar by thermopolymerization at 60° C. for 2 h.

### Example 7

The particulate filler was a mixture constituted, for 60% by weight, of a powder of vitroceramic particles of fluoro tetra mica silicate of particle size lying in the range 1 μm to 5 μm, and for 20% by weight of a zirconium silicate powder of particle size lying in the range 0.1 μm to 0.5 μm, the balance to 100% being a colloidal silica powder.

This particulate filler was subjected to silaning treatment identical to that of Example 1.

The resin presented the following composition, in percentages by weight:

| | |
|---|---|
| UDMA: | 69% |
| EGDMA: | 30% |
| MEKP: | 1% |

The paste was obtained by mixing 70% by weight of the particulate filler and 30% by weight of the resin.

The paste obtained in this way was subsequently hardened at a pressure of 2500 bar, by thermopolymerization at 90° C. for 1 h.

In the following examples, the products were fabricated from pastes that are commercially available but using a method in accordance with the invention (pressure of 2500 bar in step b)) and also using a conventional method (pressure of 1 bar). The properties of the resulting composite masses were compared.

The following tables illustrate the remarkable effectiveness of a method of the invention, regardless of the paste under consideration.

### Example 8

Starting paste: “Grandio” photopolymerizable dental composite sold by the supplier VOCO GmbH (Cuxahaven, Germany).

| Properties of the | Polymerization | Polymerization |
|---|---|---|
| composite mass | at 1 bar | at 2500 bar |
| HVN hardness | 85.7 | 114.8 |
| Specific gravity | 2.17945 | 2.18680 |
| 3-point bending (MPa) | 123.5 | 192.4 |

### Example 9

Starting paste: “Gradia” photopolymerizable dental composite sold by the supplier GC Corporation (Tokyo, Japan).

| Properties of the | Polymerization | Polymerization |
|---|---|---|
| composite mass | at 1 bar | at 2500 bar |
| HVN hardness | 33.0 | 53.8 |
| Specific gravity | 1.62501 | 1.63370 |
| 3-point bending (MPa) | 84.9 | 160.7 |

### Example 10

Starting paste: “Z100” photopolymerizable dental composite sold by the supplier 3M ESPE (St. Paul, Minn., USA).

| Properties of the | Polymerization | Polymerization |
|---|---|---|
| composite mass | at 1 bar | at 2500 bar |
| HVN hardness | 114.8 | 144 |
| Specific gravity | 2.12608 | 2.14164 |
| 3-point bending (MPa) | 138.2 | 201.1 |

As can clearly be seen from the above, the invention provides a method enabling composite blocks and prostheses to be fabricated that are particularly strong mechanically. These composite blocks are also stable chemically, presenting improved optical properties and they are easier to machine than prior art composite blocks.

Naturally, the invention is not limited to the embodiments described.

In particular, the invention is not limited by the chemical nature of the paste or by the shape of the solid mass.

1. A method of fabricating a dental prosthesis, the method comprising the following steps:
a) preparing a paste by mixing a particulate filler and a resin suitable for forming a binder phase by hardening;
b) hardening the paste prepared in step a), optionally after shaping it, so as to form a solid composite mass;
c) optionally cutting the solid composite mass so as to form at least one composite block; and
d) optionally machining the composite block so as to form a dental prosthesis;
in which method, in step b) the hardening is performed at a pressure greater than 500 bar, and the pressure is returned to atmospheric pressure once all of the resin has hardened.

2. A method according to claim 1, wherein said pressure is greater than 1000 bar.

3. A method according to claim 2, wherein said pressure is greater than 2000 bar.

4. A method according to claim 1, wherein the greatest dimension of the solid composite mass is greater than 15 mm, and the smallest dimension of the solid composite mass is less than 30 mm.

5. A method according to claim 1, wherein a temperature higher than 60° C. is applied during step b).

6. A method according to claim 5, wherein a temperature higher than 150° C. is applied during step b).

7. A method according to claim 1, wherein a temperature lower than 220° C. is applied during step b).

8. A method according to claim 1, wherein, in step a), no catalyst is added to the paste, and wherein a temperature lying in the range 150° C. to 220° C. is applied during step b).

9. A method according to claim 1, wherein a catalyst is added to the paste in step a), and wherein a temperature lying in the range 60° C. to 150° C. is applied during step b).

10. A method according to claim 1, wherein during step b) the pressure is returned to atmospheric pressure when all of the resin has hardened.

11. A method according to claim 1, wherein the particulate filler is subjected to silaning treatment prior to step a).

12. A method according to claim 1, including a step d) of machining by means of a computer-aided design-computer-aided machining device.

13. A method according to claim 1, wherein the solid composite mass results from the paste prepared in step a) being polymerized under pressure, which composite mass is then cut up into at least three composite blocks in step c).

14. A method according to claim 1, wherein, in step a), the resin is chemopolymerizable, thermopolymerizable, or thermoplastic.

15. A method according to claim 1, wherein, in step a):
the particulate filler comprises particles of a material selected from silica, a barium aluminosilicate glass, a glass containing ytterbium fluoride, albite, a micatetrafluorosilicate, a lithium disilicate, apatite, quartz, MgAl₂O₄ spinel, mullite, and zircon; and/or
the resin is a vinylester, acrylic, or methacrylic monomer resin.
